(19) United States
(12) Patent Application Publication
(10) Pub. No.: US 2007/0007798 A1
(43) Pub. Date: Jan. 11, 2007

(54) Headliner for a vehicle roof with a transparent element

(76) Inventors: Francisco Javier Martinez Moral, Burgos (ES); Carlos Selgas Caceres, Valladolid (ES); Cesar Marcos Gonzalez, Burgos (ES); Ricardo Gonzalez Merino, Burgos (ES); Ricardo Iglesias Sedano, Burgos (ES)

Correspondence Address: KATTEN MUCHIN ROSENMAN LLP, 575 MADISON AVENUE, NEW YORK, NY, 10022-2585, US

(21) Appl. No.: 11/437,437

(22) Filed: May 19, 2006

(30) Foreign Application Priority Data
May 19, 2005 (EP) 05380100.7

(51) Int. Cl. B60J 7/00

(52) U.S. Cl. 296/214; 296/215

(57) ABSTRACT

The headliner comprises guiding means (2) for a concealing element (3), part of a system for concealing a transparent element provided in the roof of a vehicle, guiding means (2) that are disposed in line with the perimeter of at least one opening (4) in said interior lining trim (1) provided to match up with the transparent element in the roof of the vehicle. The guiding means (2) are connected up and supported by said interior lining trim (1), said guiding means (2) acting as a reinforcement element so as to form a strong assembly, which supports the weight of the concealing system and the stresses generated during its operation, together with the interior lining trim (1).

### CROSS REFERENCE TO RELATED APPLICATION

This applications claims priority to European Patent Application Number 05380100.7 filed May 19, 2005, the contents of which are herein incorporated by reference.

### OBJECT OF THE INVENTION

The headliner of the invention is for application to vehicle roofs provided with a transparent element that allows the light to pass through said roof.

The object of the invention is a headliner comprising a conventional interior lining trim that includes guiding means for a concealing element of a concealing system for a transparent element of the vehicle roof, permitting the installation of the interior lining trim and the concealing system in a single operation.

The guiding means are arranged to act as a reinforcing element for the interior lining trim, so that the assembly made up of the interior lining trim and the guiding means form a strong unit capable of withstanding the weight of the concealing system and the stresses generated during its operation.

The object of the invention is also a headliner which includes a concealing system as well as the guiding means.

### BACKGROUND OF THE INVENTION

Today vehicles including transparent elements in their roof are well known. They usually have a concealing system to block or permit the passage of light to the interior of the passenger compartment by way of the aforesaid transparent element.

A concealing system is an assembly that comprises a concealing element, usually a roller blind, a transversal rod fitted at the front edge of the blind to enable it to be pulled out, a coiling body that enables the blind to be stowed away, and operating means that comprise a drive motor and cables or wires that transmit the movement from the drive motor to the concealing element to be pulled out or folded away. These systems sometimes include a cover for the coiling body which comprises at least one skirt that presses on the concealing element to provide a tension that prevents wrinkles from forming.

The rods that enable the blind to be folded out are linked at their ends to operating cables and slide inside guide rails provided in a carrier element fitted with means for fastening them to the vehicle body. These guide rails are normally factory-made by extrusion and usually have a complex section.

The carrier element generally consists of a sealed frame incorporating two longitudinal tiebars, matching up with the guide rails and two cross rails parallel to the front and rear cross members of the vehicle roof structure. This layout involves costly installation and requires several operations to connect up the elements and form a sealed frame, such as bending, screwing and riveting. This frame has to be very strong as it supports all the concealing system components and is therefore usually of considerable thickness and weight.

The concealing system is anchored directly to the vehicle structure by means of the support frame, an interior lining trim being secured to said frame and roof.

These systems have the following drawbacks:
The manufacturing of the guide rails requires the use of complicated manufacturing and installation methods, such as for instance extruding, bending, die stamping, riveting, etc., which increases the final price of the concealing system.
The guide rails increase the thickness of the concealing system, thus reducing the vehicle accommodation and establishing a distance from the concealing element to the transparent roof element.
Considerable weight.

Concealing systems for vehicles are described, for example, in Patents UK 2.220.392, UK 2.335.397, JP 2002274180.

### DESCRIPTION OF THE INVENTION

The present invention resolves the problems described on the basis of a conventional interior lining trim incorporating guiding means for a concealing element that are built into the actual interior lining trim and, therefore, connected to and supported by said interior lining trim. A conventional interior lining trim is considered to be a self-supporting multi-layer trim provided with one or more openings that permit visual access to one or more transparent elements provided in the vehicle roof.

The concealing element guide means also act as a reinforcement for the interior lining trim, so that the assembly formed of the interior lining trim and the guide means is able to bear the weight of the concealing system and the stresses generated during its operation.

The guiding means are designed to form a light structure without incorporating reinforcing frames of considerable thickness and weight, so that they do not represent an excessive increase in the weight of the interior lining trim and, therefore, would not be capable of supporting the concealing system by themselves. The strength and rigidity necessary to support the concealing system is achieved by means of the sum of the strength supplied by the interior lining trim and by the guiding means. This means that neither the interior lining trim nor the guiding means meet the strength and rigidity requirements by themselves.

In this way, it is possible to fix the assembly made up of the interior lining, together with the guiding means and concealing system, to the vehicle body in a single operation. For this attachment the standard interior lining trim fixing elements are used as well as some additional fixing elements provided in the guiding means.

The guiding means are disposed to match up with the perimeter of the opening or openings in the interior lining trim and comprise guide rails, for sliding the concealing element, and supports that enable the guide rails to be fitted to the interior lining trim, and they act as reinforcing elements for said interior lining trim. These supports are spread over the whole length of the aforesaid guide rails to ensure that they are fastened to the interior lining trim at numerous points, which will achieve an increase in the strength and rigidity of the interior lining trim distributed all round the perimeter of its opening or openings. In this way, small lightweight supports can be used that provide a sufficient increase in the strength of the interior lining trim in order to be able to support the concealing system.

The guiding means also comprise a reinforcement strip that is mounted directly on the interior lining trim, matching up with the perimeter of the opening or openings in the interior lining trim. In this case, the guiding means supports are anchored to this reinforcement strip, thereby conferring greater strength on the assembly with only a small increase in its weight.

To facilitate the production process, it is also foreseen that the guide rails and supports should be obtained as a single piece.

The supports could also be built into the reinforcement strip to form a single piece.

Finally, the reinforcement strip, supports and guide rails could be obtained in a single piece.

The aforesaid concealing system may be, for instance, a single blind system or a double blind system.

The trim of the invention offers the following advantages:
Reduced weight and size of the whole system. The elimination of the normal support frame, which comprises the front and rear cross rails and the longitudinal rails, represents a reduction in the size and weight of the concealing element support and guide means.
Reduction in the parts to be assembled. The number of parts making up the system is smaller because there is no support frame.
Fewer assembly operations. As the concealing system is not a separate part, which has to be fitted independently to the vehicle structure for the interior lining trim to be installed on it afterwards, an assembly operation is eliminated. For the same reason, this also give rise to a reduction in the number of assembly machines and jigs needed, less works space used and fewer personnel involved.
Less height space needed and, therefore, increased accommodation.
The space between the interior lining trim and the transparent element needed to house the concealing system is reduced, which means more accommodation space inside the vehicle.
Impression of quality of the end product. The quality of the fit between the interior lining trim and the concealing element is easier to control as we go from having to control two independent parts that are fitted to the roof, as in current systems, to having to control just one part. This means that greater reliability is achieved in the adjustments between parts and, therefore, an enhanced final overall appearance.

### DESCRIPTION OF THE DRAWINGS

To supplement the description being given and in order to assist a better appreciation of the features of the invention, there is a set of drawings attached as an integral part of said description wherein there is represented, for illustrative but not restrictive purposes, the following:

FIG. 1.—It represents an exploded perspective view of the headliner of the invention consisting of an interior lining trim and guiding means for a concealing element, composed of guide rails and supports.

FIG. 2.—It represents an exploded perspective view of the headliner of the invention composed of an interior lining trim and guiding means for a concealing element incorporating an additional reinforcement strip.

FIG. 3.—It represents an exploded perspective view of a headliner according to the object of the invention, composed of the items in FIG. 2, which also incorporates a double blind concealing system.

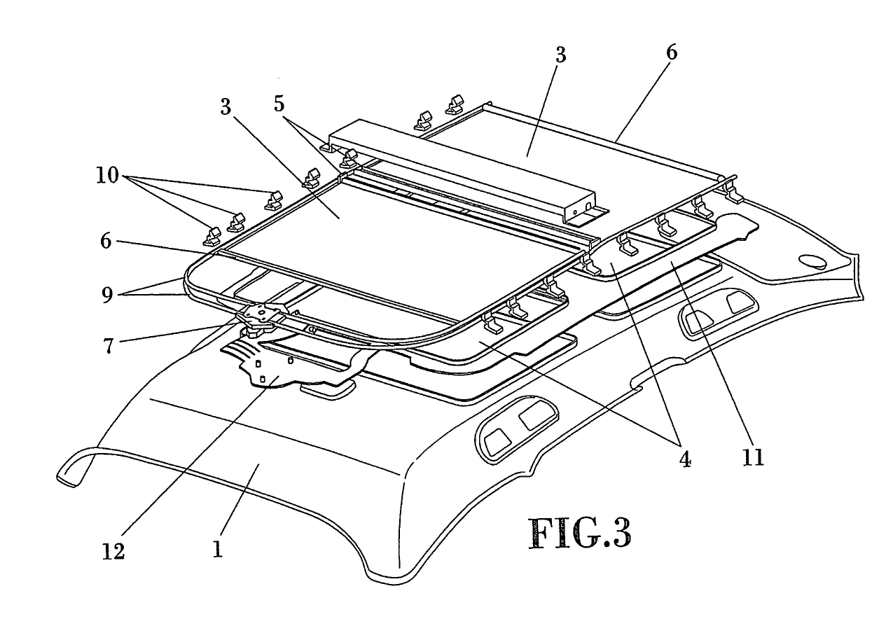

FIG. 4.—It represents a view from the top, i.e. from the part that faces the vehicle body, of the headliner represented in the previous figure with all the elements properly installed, including a double blind concealing system.

FIG. 5.—It represents a view from the top, i.e. from the part that is visible from the vehicle passenger compartment, of the headliner represented in the previous figure with all the elements properly installed, including a double blind concealing system.

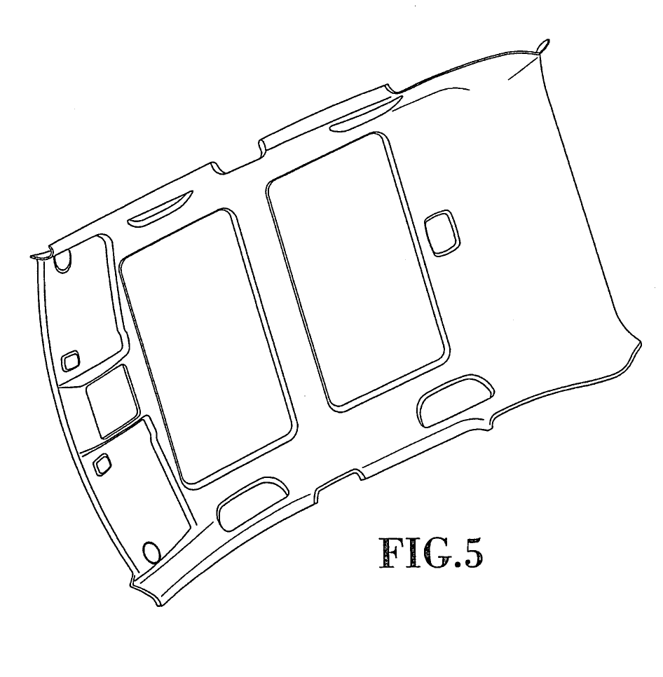

FIG. 6.—It represents a close view of the guiding means, composed of a hollow tube housing the operating cable and the slider provided at one of the ends of the transversal rod connected to the free end of a blind. This figure also represents an embodiment of the fixing support for said hollow tube.

### PREFERRED EMBODIMENT OF THE INVENTION

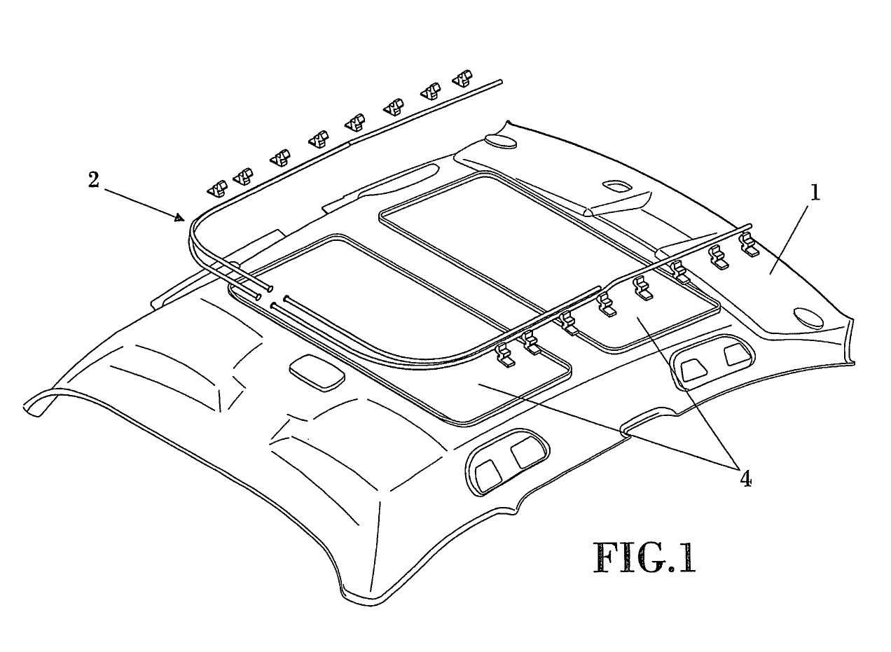

As is seen in FIG. 1, the vehicle headliner of the invention is composed of a conventional interior lining trim (1) and guiding means (2) for concealing elements (3), as part of a system for the concealment of one or more transparent elements provided in the vehicle roof.

A conventional headliner is taken to mean a multilayer trim which, as may be observed in the above-mentioned FIG. 1, has one or more openings (4) that provide direct access to the transparent elements of the vehicle roof, as well as a series of elements for fastening the interior lining trim (1) to the vehicle body.

A concealing system is one that comprises all the necessary means to block or permit the passage of light to the interior of the passenger compartment by way of the transparent elements provided in the vehicle roof. A concealing element (3) is a fold-out element, usually a blind, which is disposed matching up with the transparent element in the roof after its concealment.

In the embodiments shown in the figures a vehicle roof trim is represented that has two transparent elements and a concealing system of the so-called “double blind” type.

Said concealing system comprises two concealing elements (3), for instance two blinds, two coiling bodies (5) and transversal rods (6) fitted at the free end of each blind (3) to assist their pulling out. Said concealing system also comprises means for operating each concealing element (3), which, in the embodiment represented, are composed of a motor (7) that moves sliders (13) by way of operating cables (8), as will be described later on. The blinds (3) may be fitted with intermediate reinforcing rods, in a transverse arrangement.

The guiding means are made up of a guide rail (9), for each one of the concealing elements or blind (3), and supports (10) which are spread around the outside edge of the openings (4), forming reinforcement means distributed to improve the strength and rigidity of the interior lining trim (1) as well as to provide support for the concealing system.

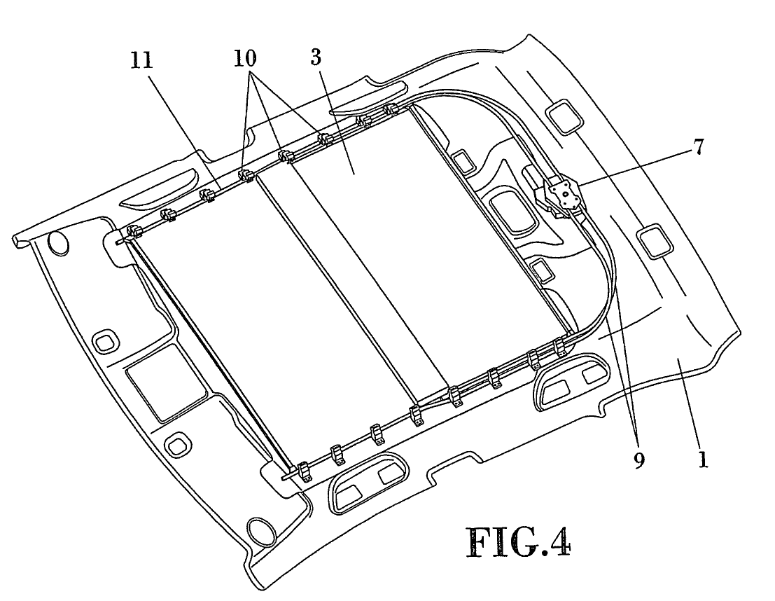

In this way, the headliner represented in FIG. 4 constitutes a pre-assembled unit that enables the interior lining trim (1) and the concealing system to be fixed to the vehicle roof in a single operation. The fixing means, not shown, comprise fixing means for a conventional interior lining trim (1) and additional fixing means provided in the guiding means.

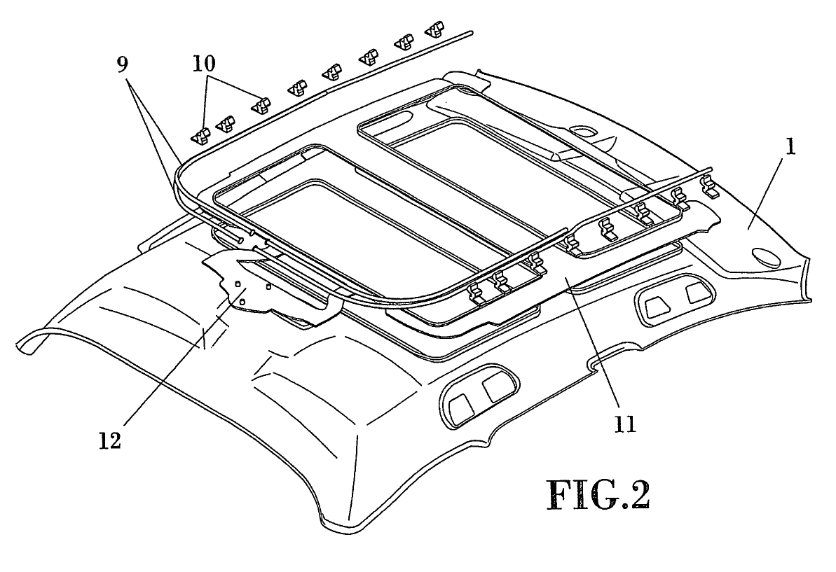

As may be seen in FIG. 2, the headliner of the invention also comprises a reinforcement strip (11), which is disposed matching up with the perimeter of the openings (4) in the interior lining trim (1) and fixed directly to the aforesaid interior lining trim. As may also be observed in this figure, the guiding means supports (10) are installed on the trim by way of the reinforcement strip (11).

In this case the guiding means supports (10) are installed on the above-mentioned reinforcement strip (11).

The reinforcement strip (11) also includes a support (12) for the concealing element drive motor (7).

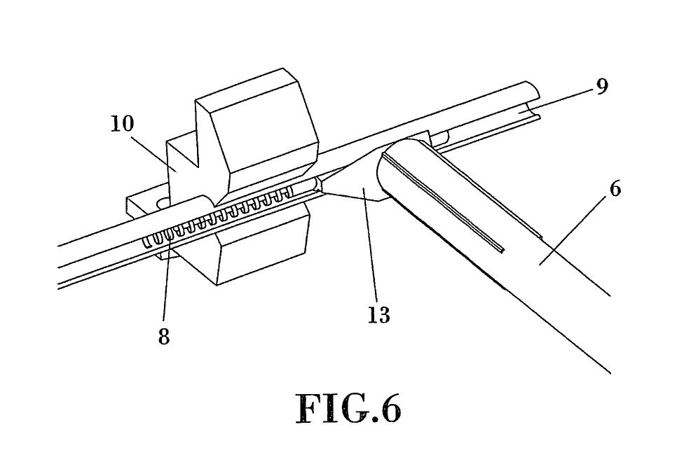

As may be seen in FIG. 6, the guide rails (9) are made up of hollow slotted tubes housing the operating cables (8) and sliders (13) provided at the ends of transversal rods (6) of the blinds (3). The sliders (13) slide inside the slotted hollow tubes (9) and are connected to the end of the operating cables (8).

Said sliders (13) may be riveted as shown in FIG. 6, or else superinjected onto the respective operating cables (8).

In the embodiment shown in the figures, four hollow slotted tubes (9), two for each one of the blinds (3), are represented, having different lengths according to the position of each of the blinds (3). Obviously, if the concealing element were made up of a single blind (3), the guiding means would comprise two hollow slotted tubes (9).

In one embodiment of the invention, the guide rails (9) may consist of a single plastic part incorporated in the supports (10) which in turn would be installed on the reinforcement strip (11).

In an alternative embodiment, the reinforcement strip (11) is made up of a plastic part incorporated in the supports (10), or even in another alternative embodiment could also be incorporated in the guide rails (9).

1. Headliner for a vehicle roof with a transparent element, the headliner comprising:
a conventional interior lining trim (1) having at least one opening (4) that permits visual access to the aforesaid transparent element in the roof and provided with means for its fixing to the vehicle body,
wherein the interior lining trim comprises guiding means (2) for a concealing element (3), part of a system for concealing the aforesaid transparent element, guiding means (2) which are disposed around the perimeter of the cited at least one opening (4) in said interior lining trim (1), the afore-mentioned guiding means (2) being joined to and supported by said interior lining trim (1), said guiding means (2) acting as a reinforcing element to form, together with the interior lining trim (1), a strong assembly that supports the weight of the concealing system and the stresses generated during its operation.

2. Headliner for a vehicle roof with a transparent element, according to claim 1, characterised in that said guiding means (2) comprise guide rails (9) and supports (10), the cited supports (10) being spread over the length of the aforesaid guide rails (9), for their fixing to the interior lining trim (1) in numerous points, thereby increasing the rigidity of the interior lining trim in a well-distributed fashion around the perimeter of the cited at least one opening (4).

3. Headliner for a vehicle roof with a transparent element, according to claim 1, characterised in that said guiding means (2) also comprise a reinforcement strip (11) mounted on the interior lining trim (1) so as to match up with the perimeter of the cited at least one opening (4) in said interior lining trim (1), said guiding means (2) being fitted on said reinforcement strip (11).

4. Headliner for a vehicle roof with a transparent element, according to claim 2, characterised in that said supports (10) and said guide rails (9) are formed in one piece.

5. Headliner for a vehicle roof with a transparent element, according to claim 4, characterised in that said piece is a plastic piece.

6. Headliner for a vehicle roof with a transparent element, according to claim 3, characterised in that said supports (10) and said reinforcement strip (11) are formed in one piece.

7. Headliner for a vehicle roof with a transparent element, according to claim 6, characterised in that said piece is a plastic piece.

8. Headliner for a vehicle roof with a transparent element, according to claim 3, characterised in that said supports (10), said guide rails (9) and said reinforcement strip (11) are formed in one piece.

9. Headliner for a vehicle roof with a transparent element, according to claim 8, characterised in that said piece is a plastic piece.

10. Headliner for a vehicle roof with a transparent element, according to claim 1, characterised in that said concealing element (3) is a blind concealing element.

11. Headliner for a vehicle roof with a transparent element, according to claim 1, which comprises a concealing element supported conjointly by the interior lining trim (1) and the guiding means (2), as well as operating means for the concealing element (3).

12. Headliner for a vehicle roof with a transparent element, according to claim 11, characterised in that said operating means comprise a motor (7) and at least one operating cable (8).

13. Headliner for a vehicle roof with a transparent element, according to claim 11, characterised in that said operating means comprise manual operating means and at least one operating cable (8).

14. Headliner for a vehicle roof with a transparent element, according to claim 11, characterised in that the concealing system is made up of at least one blind (3), at least one coiling body (5) and a transversal rod (6) connected to the free end of said at least one blind (3).

15. Headliner for a vehicle roof with a transparent element, according to claim 14, characterised in that said at least one blind (3) incorporates at least one intermediate reinforcement rod.

16. Headliner for a vehicle roof with a transparent element, according to claim 14, characterised in that said guide rails are made up of at least one hollow slotted tube that acts as a housing for said operating cable (8) and for sliders (13) provided at one end of said transversal rod (6).

17. Headliner for a vehicle roof with a transparent element, according to claim 16, characterised in that said sliders (13) have a tubular end (14) with an outer surface that slides under guidance inside the at least one hollow slotted tube and inside which there is housed a portion of the operating cable (8), which has its position locked in relation to said slider (13) by way of bushings (15) riveted to the cable which are disposed at the ends of the tubular portion of the slider.

18. Headliner for a vehicle roof with a transparent element, according to claim 17, characterised in that said sliders (13) are superinjected onto the respective operating cables (8).
